(19) United States
(12) Patent Application Publication
(10) Pub. No.: US 2024/0191707 A1
(43) Pub. Date: Jun. 13, 2024

(54) Electric Pump And Compressor Assembly, Systems Comprising Same, And Methods Of Using Same

(71) Applicant: Nott Company, Arden Hills, MN (US)

(72) Inventors: Dusten Carl O'Konek, JR., Henderson, MN (US); Anthony Reid Hennum, Shakopee, MN (US)

(21) Appl. No.: 18/538,031

(22) Filed: Dec. 13, 2023

Related U.S. Application Data
(60) Provisional application No. 63/432,251, filed on Dec. 13, 2022.

(51) Int. Cl. F04B 41/06; F04B 39/00; F04C 29/00; F04C 29/06; F15B 15/18

(52) U.S. Cl. CPC F04B 41/06; F04B 39/005; F04C 29/0042; F04C 29/063; F15B 15/18

(57) ABSTRACT

The disclosure relates to an assembly comprising an electric motor that simultaneously drives both a pump and a compressor. The assembly can be used in a motor vehicle. The pump can be suited particularly for generating hydraulic fluid flow for steering and braking, or to perform auxiliary functions such as dump bodies for garbage trucks or landscape trucks. Methods of operating the system and manufacturing the system are also provided.

### CROSS-REFERENCE TO RELATED APPLICATION

This application claims priority to and the benefit of the filing date of U.S. Provisional Patent Application No. 63/432,251, filed Dec. 13, 2022, the entirety of which is hereby incorporated by reference herein.

### FIELD

The disclosure relates to an electric pump and compressor assembly that can be used in a motor vehicle. The pump of the assembly can be used, for example, for generating hydraulic fluid flow for steering and braking, or to perform auxiliary functions such as dump bodies for garbage trucks or landscape trucks. The compressor can be used for supplying pneumatic power to devices such as pneumatic brakes or pneumatic tools. Methods of operating the system and manufacturing the system are also provided.

### BACKGROUND

The automobile industry has developed rapidly in recent decades and moved toward electric propulsion in lieu of internal combustion engines. An electric pump has been required to replace a conventional mechanical pump to provide hydraulic fluid flow for the traditional vehicle operations such as braking and steering, as well as auxiliary functions for vocational vehicles. Use of the electric pump also allows movement towards a safer, more reliable, more stable, fully-automatic and intelligent, and environmental friendly and energy saving trend by allowing closer control of the operation of the unit. The electric pump has advantages of being efficient and environmental friendly and capable of being adjusted continuously, which can meet the requirements of market well. An electrically powered compressor can provide similar benefits.

### SUMMARY OF EMBODIMENTS

The present disclosure provides a system including a motor comprising an output shaft. The system can further include an air compressor comprising a drive shaft coupled to the output shaft of the motor so that rotation of the motor drives the air compressor and a hydraulic pump comprising a drive shaft that is coupled to the output shaft of the motor so that rotation of the motor drives the hydraulic pump.

A method comprising coupling an output shaft of a motor to a drive shaft of an air compressor so that rotation of the motor drives the air compressor and coupling the output shaft of the motor to a drive shaft of a hydraulic pump so that rotation of the motor drives the hydraulic pump.

### BRIEF DESCRIPTION OF DRAWINGS

The invention will now be described, by way of example, with reference to the accompanying drawings in which:

FIG. 1 is schematic view showing the structure of an embodiment of an assembly comprising a motor, an electric pump, and a compressor, a container for the assembly, and bulkhead fittings for affixing the assembly inside the container in accordance with the present disclosure.

FIG. 2 is the schematic view of the structure shown in FIG. 1, shown from a different angle.

FIG. 3 is a schematic view of an assembled system comprising the assembly, container, and bulkhead fittings of FIG. 1.

FIG. 4 is a schematic view of the assembled system of FIG. 3, shown from a different angle.

FIG. 5 is a schematic view of the structure shown in FIG. 1, with the motor, the electric pump, and the compressor in an exploded configuration.

FIG. 6 is another exploded view of the structure shown in FIG. 1.

FIG. 7 is a schematic view of a vehicle comprising the assembly comprising the motor, the electric pump, and the compressor as shown in FIG. 1.

FIG. 8 is a block diagram of a control system for controlling operation of the system of FIG. 1

### DETAILED DESCRIPTION OF EMBODIMENTS

Before the present systems and methods are described, it is to be understood that the present disclosure is not limited to the particular processes, compositions, or methodologies described, as these may vary. It is also to be understood that the terminology used in the description is for the purposes of describing the particular versions or embodiments only, and is not intended to limit the scope of the present disclosure. Unless defined otherwise, all technical and scientific terms used herein have the same meanings as commonly understood by one of ordinary skill in the art. Although any methods and materials similar or equivalent to those described herein can be used in the practice or testing of embodiments of the present disclosure, the methods, devices, and materials in some embodiments are now described. All publications mentioned herein are incorporated by reference in their entirety. Nothing herein is to be construed as an admission that the present disclosure is not entitled to antedate such disclosure by virtue of prior invention.

### Definitions

Unless otherwise defined herein, scientific and technical terms used in connection with the present disclosure shall have the meanings that are commonly understood by those of ordinary skill in the art. The meaning and scope of the terms should be clear. However, in the event of any latent ambiguity, definitions provided herein take precedent over any dictionary or extrinsic definition. Further, unless otherwise required by context, singular terms shall include pluralities and plural terms shall include the singular.

The indefinite articles “a” and “an,” as used herein in the specification and in the claims, unless clearly indicated to the contrary, should be understood to mean “at least one.” However, when “a” or “an” is used with reference to a particular element, it is understood that the disclosure provides support for an embodiment in which only a single one of the disclosed elements is provided. The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above unless context dictates otherwise. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, “either,” “one of,” “only one of,” or “exactly one of.” “Consisting essentially of,” when used in the claims, shall have its ordinary meaning as used in the field of patent law.

The term “about” is used herein to mean within the typical ranges of tolerances in the art. For example, “about” can be understood as about 2 standard deviations from the mean. According to certain embodiments, when referring to a measurable value such as an amount and the like, “about” is meant to encompass variations of ±20%, ±10%, ±5%, ±1%, ±0.9%, ±0.8%, ±0.7%, ±0.6%, ±0.5%, ±0.4%, ±0.3%, ±0.2% or ±0.1% from the specified value as such variations are appropriate to perform the disclosed methods. When “about” is present before a series of numbers or a range, it is understood that “about” can modify each of the numbers in the series or range.

The term “at least” prior to a number or series of numbers (e.g. “at least two”) is understood to include the number adjacent to the term “at least,” and all subsequent numbers or integers that could logically be included, as clear from context. When “at least” is present before a series of numbers or a range, it is understood that “at least” can modify each of the numbers in the series or range. Ranges provided herein are understood to include all individual integer values and all subranges within the ranges.

As used herein, the terms “comprising” (and any form of comprising, such as “comprise,” “comprises,” and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, unrecited elements or method steps.

### Systems

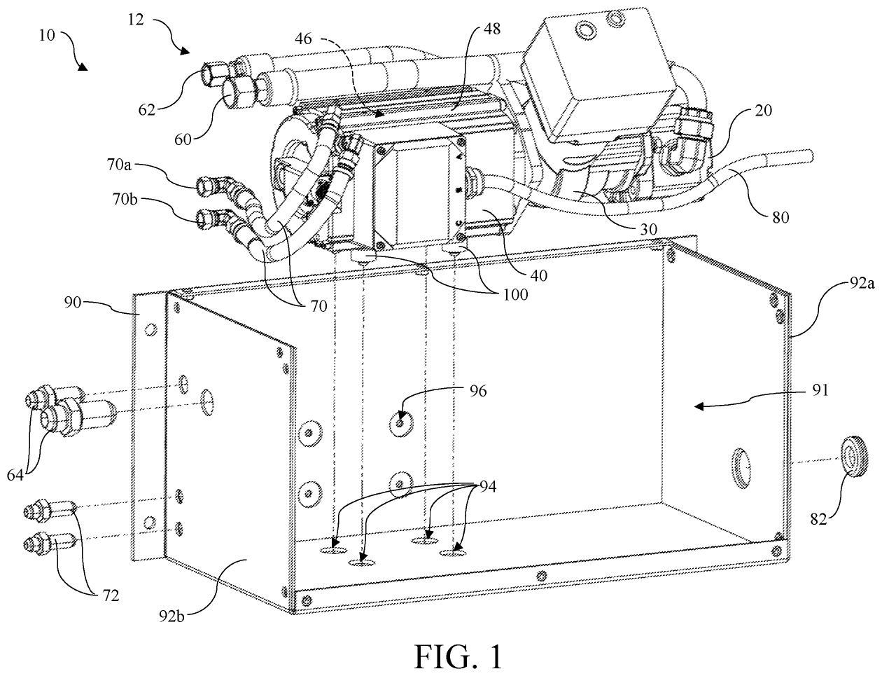

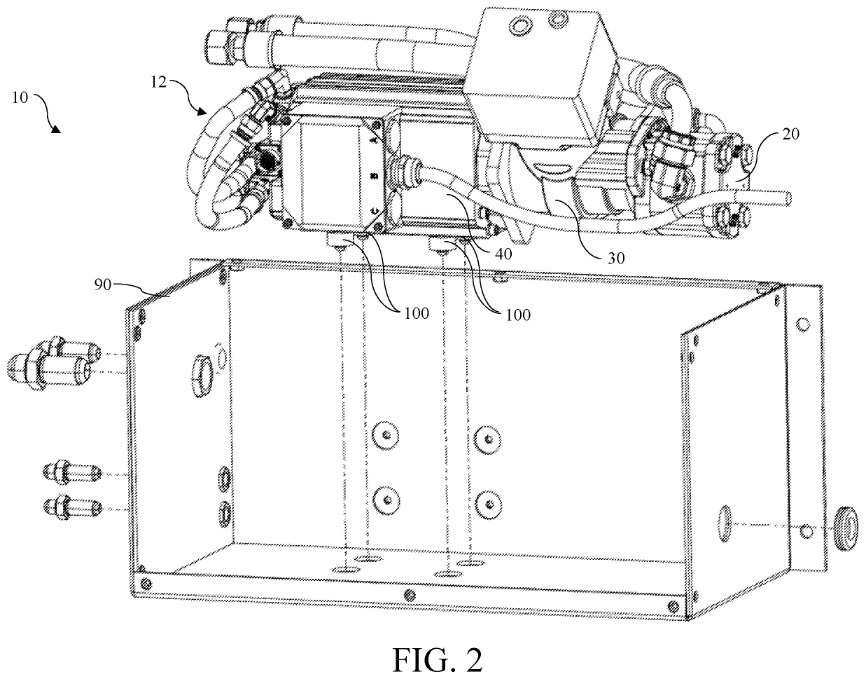

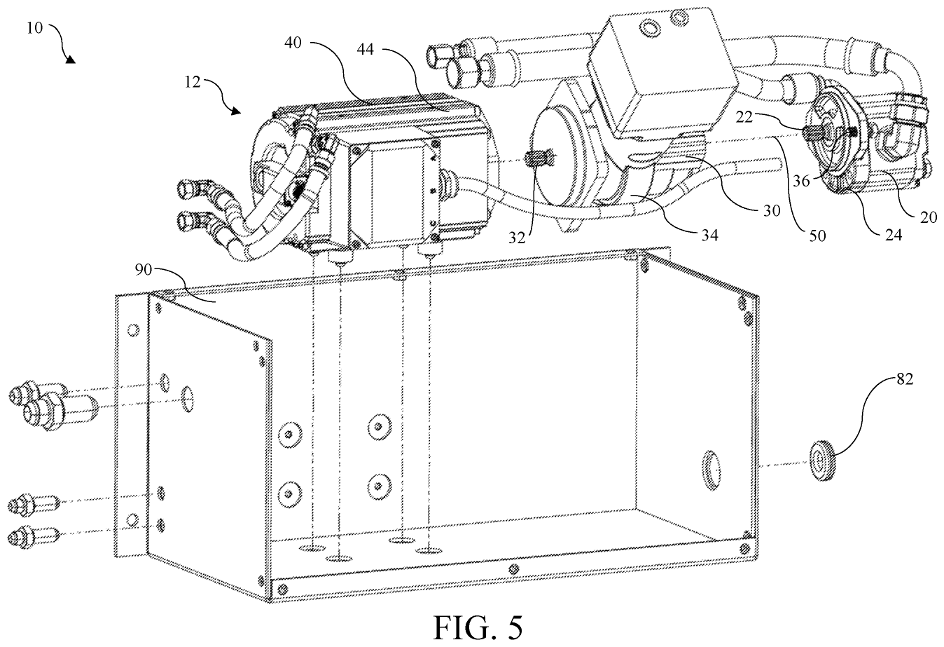

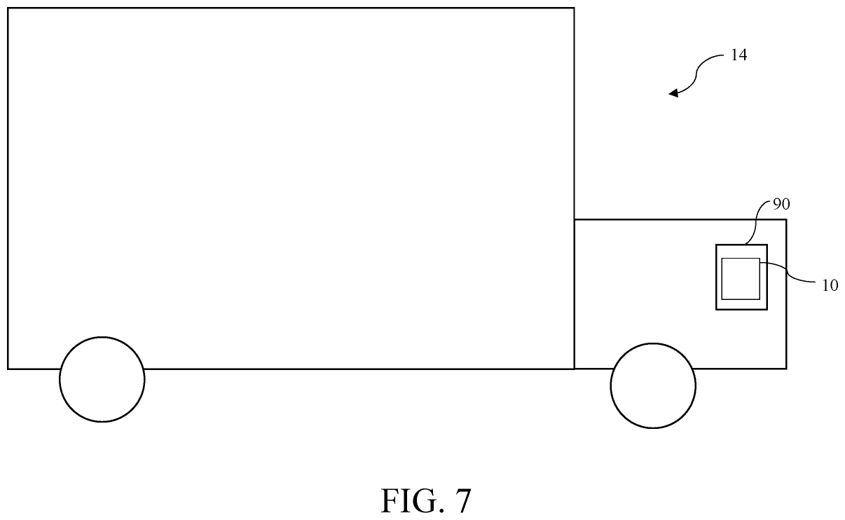

Referring to FIGS. 1-6, the disclosure relates to a system 10, particularly, a system 10 having an assembly 12 comprising a pump 20 and a compressor 30 that are electrically powered by a motor 40 (e.g., an electric motor). The assembly 12 can be used in a motor vehicle 14 (FIG. 7). In exemplary aspects, the pump 20 can be part of a hydraulic system of the vehicle 14, and the compressor 30 can be part of a pneumatic system of the vehicle.

The vehicle 14 can be any type of machine that transports a user or material or performs one or a plurality of applications. For example, the vehicle 14 can be any form of self-propelled vehicle, such as, but not limited to, a light or heavy duty truck, specialty truck, construction equipment, farming equipment, cleaning vehicle, and the like. Examples of the vehicle 14 can include, but are not limited to, a bucket lift truck, a garbage truck, a crane transport, a crop harvester, a street vacuum, a street sweeper, a moving truck, or a concrete mixing truck.

In other aspects, the system 10 can be used with non-vehicle machinery or equipment, such as construction equipment, farming equipment, cranes, drilling equipment, and the like.

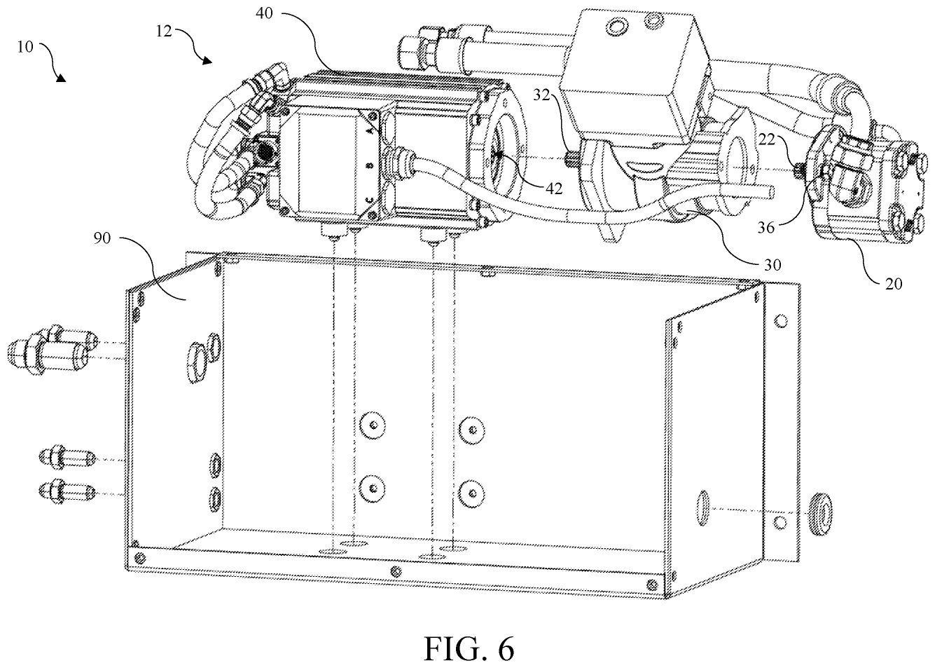

Reference is made to FIGS. 1 and 6 which shows a schematic view of an embodiment of such a system 10. In the system 10 shown in FIGS. 1 and 6, the motor 40 can have an output shaft 42. The compressor 30 (also referred to herein as an “air compressor”) can have a drive shaft 32 that is coupled to the output shaft 42 of the motor 40 so that rotation of the motor drives the air compressor. The pump 20 (also referred to herein as a “hydraulic pump”) can have a drive shaft 22 that is coupled to the output shaft 42 of the motor 40 so that rotation of the motor drives the pump 20. For example, in some optional aspects and as shown, the output shaft 42 of the motor 40 can couple to the drive shaft 32 of the compressor 30, and the drive shaft of the compressor can, in turn couple to the drive shaft 22 of the pump 20. Thus, for example, the drive shaft 32 of the compressor 30 can have first and second longitudinal end portions. The output shaft 42 of the motor 40 can couple to the first longitudinal end portion of the drive shaft 32 of the compressor 30, and the drive shaft 22 of the pump 20 can couple to the second longitudinal end portion of the drive shaft 32 of the compressor 30. In alternative aspects, the output shaft 42 of the motor 40 can couple to the drive shaft 22 of the pump 20, and the drive shaft 22 of the pump 20 can, in turn couple to the drive shaft 32 of the compressor 30. That is, in some optional aspects, the respective positions of the pump 20 and compressor 30 can optionally be switched from the illustrated embodiment so that the pump 20 is positioned between the motor 40 and the compressor 30.

In the illustrated embodiment, the output shaft 42 of the motor 40 is shown as a female shaft, and the drive shaft 32 of the compressor 30 is a male shaft. The female shaft of the motor is configured to receive the male shaft of the compressor 30. However, it is contemplated that any suitable configuration of shaft couplings can be used. For example, the male and female shafts of the compressor and motor can be switched so that the output shaft of the motor is a male shaft, and the drive shaft of the compressor is a female shaft. Optionally, the output shaft 42 of the motor 20, the drive shaft 32 of the compressor 30, and/or the drive shaft 22 of the pump can all comprise one or a plurality of splines that are configured to engage to transfer rotational motion to an adjacent output/drive shaft. In other aspects, keyed couplings can be used to couple adjacent output/drive shafts. Optionally, a shaft coupling sleeve (not shown) can couple adjacent shafts (e.g., the output shaft 42 of the motor 40 and the drive shaft 32 of the compressor 30; the output shaft 42 of the motor 40 and the drive shaft 22 of the pump 20; or the drive shaft 32 of the compressor 30 and the drive shaft 22 of the pump 20).

In some optional aspects, the drive shaft 32 of the compressor 30 can be coupled to the drive shaft 22 of the pump 20 so that that the compressor 30 and the pump 20 are configured rotate at the same speed. Accordingly, in some aspects, the respective displacements of the pump 20 and the compressor 30 can be selected so that the pump and the compressor can be operated at the same speed. In alternative aspects, a gearbox (not shown) can be positioned in operable coupling between the pump 20 and the compressor 30 in order to adjust the relative speed between the pump 20 and the compressor 30.

In some optional aspects, the output shaft 42 of the motor 40, the drive shaft 32 of the compressor 30, and the drive shaft 22 of the pump 20 can be arranged coaxially so that the output shaft and drive shafts are configured to rotate about a single axis 50.

The motor 40 can comprise a housing 44. The air compressor 30 can comprise a housing 34; and the pump 20 can comprise a housing 24. In some optional aspects, the housing 34 of the compressor 30 can be coupled to the housing 44 of the motor 40. For example, fasteners (e.g., screws, bolts, or the like) can extend between and couple the housing 34 of the compressor 30 and the housing 44 of the motor 40. In other aspects, the housing 24 of the pump 20 can be coupled to the housing 44 of the motor 40. For example, fasteners (e.g., screws, bolts, or the like) can extend between and couple the housing 24 of the pump 20 and the housing 44 of the motor 40. In some aspects, an adapter plate or bell housing (not shown) can be positioned between the motor 40 and the adjacent one of the pump 20 or the compressor 30 in order to permit coupling therebetween.

In some aspects, the housing 34 of the compressor 30 can be coupled to the housing 24 of the pump 20. For example, optionally, fasteners 36 (e.g., screws, bolts, or the like) can extend between and couple the housing 24 of the pump 20 and the housing 34 of the compressor 30. In some aspects, an adapter plate or bell housing (not shown) can be positioned between the pump 20 and compressor 30 in order to permit coupling therebetween.

In exemplary, optional aspects, the motor 40 can be a Parker GVM motor. As illustrated, the compressor 30 can be positioned on the right of the motor 40, and the pump 20 can be positioned on the right of the compressor. The pump 20 can comprise a fluid inlet 60 and a fluid outlet 62. Each of the fluid inlet 60 and the fluid outlet 62 can be in closed fluid communication with one or a plurality of fluid conduits that define a fluid circuit. In some embodiments, each of the fluid inlet 60 and the fluid outlet 62 can comprise hose or tube. In some embodiments, each of the fluid inlet 60 and the fluid outlet 62 can further comprise one or a plurality of fittings, such as bulkhead fittings. Any type of hydraulic pump can be used in the disclosed system, including, but not limited to, rotary vane pump, gear pump, screw pump, bent axis pump, inline axial piston pump and radial piston pumps. In some embodiments, the hydraulic pump in the disclosed system is a rotary vane pump, as shown in FIG. 1. In some embodiments, the hydraulic pump in the disclosed system is a gear pump. In some embodiments, the hydraulic pump in the disclosed system is a screw pump. In some embodiments, the hydraulic pump in the disclosed system is a bent axis pump. In some embodiments, the hydraulic pump in the disclosed system is an inline axial piston pump. In some embodiments, the hydraulic pump in the disclosed system is a radial piston pumps. Similarly, any type of compressor 30 can be used in the disclosed system. For example, in some aspects, and as illustrated, the compressor 30 can be a piston compressor. In some aspects, the compressor 30 can be a scroll compressor. In some aspects, the compressor 30 can be a screw compressor.

The system shown in FIG. 1 further comprises a plurality of coolant lines 70. For example, the system 10 can comprise a first second coolant lines 70a,b. Each of the first and the second coolant lines 70a,b can comprise a hose or tube. In some embodiments, each coolant line 70 further comprises one or a plurality of fittings, such as bulkhead coolant fittings 72. In some embodiments, the first coolant line 70a defines a fluid pathway for coolant around the motor, wherein a first segment of this first coolant line is positioned along an outside periphery 66 of the motor 40 and a second segment of this first coolant line 70a is positioned along an interior 48 of the motor 40. In some embodiments, the second coolant line 70b is operably connected to the first coolant line and defines a fluid pathway for coolant around the motor, wherein a first segment of this second coolant line is positioned along the interior 46 of the motor 40 and a second segment of this second coolant line is positioned along the outside periphery 48 of the motor.

In some embodiments, the first coolant line 70a comprises at least one segment that runs along a longitudinal axis of the motor 40. In other embodiments, the second coolant line 70b comprises at least one segment that runs along a longitudinal axis of the motor. In some embodiments, the first coolant line 70a comprises at least one segment that runs along a longitudinal axis of the pump 20. In other embodiments, the second coolant line 70b comprises at least one segment that runs along a longitudinal axis of the hydraulic pump 20.

The system shown in FIG. 1 also comprises one or more electric cables 80 connecting the electric motor to an inverter (not shown).

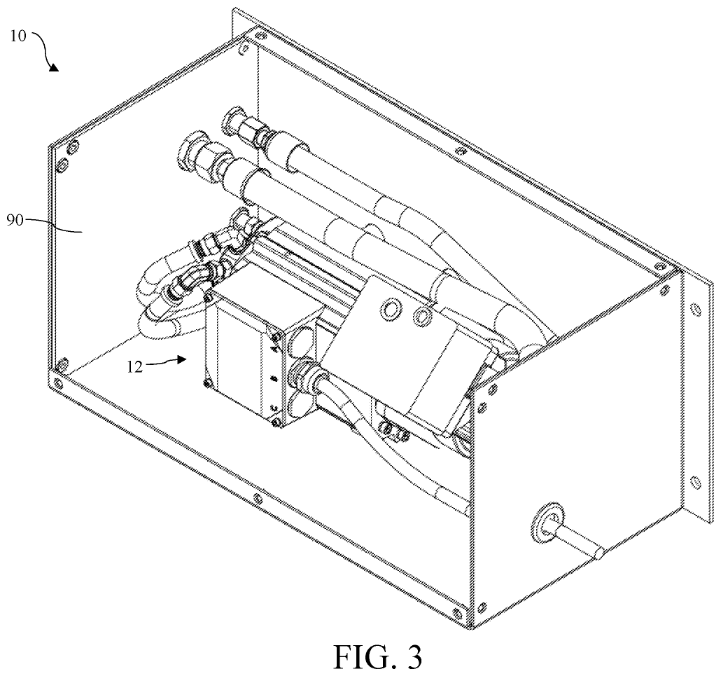

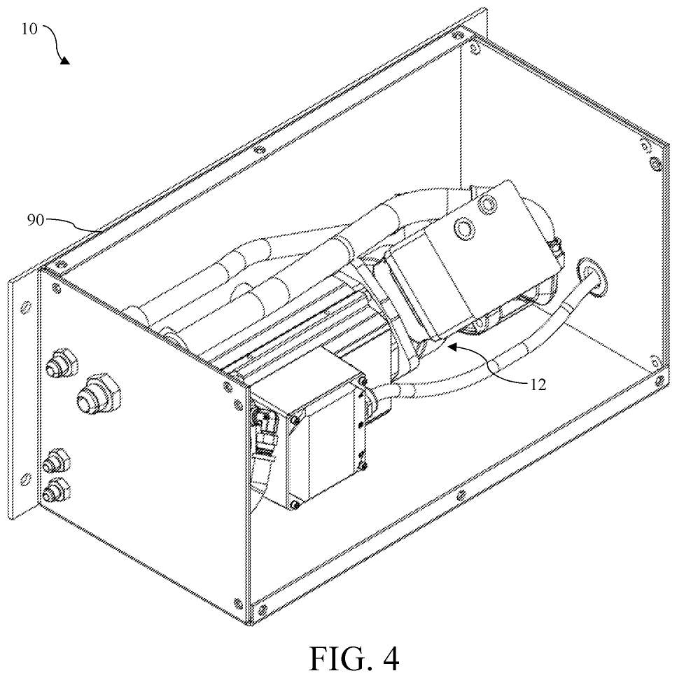

Also shown in FIG. 1 is a container 90 within which the assembly 12 can be received and affixed. The container 90 can define an interior 91 within which each of the motor 40, the hydraulic pump 30, and the compressor 20 can be received. For example, the container 90 can encompasses the motor 40, the hydraulic pump 30, and the compressor 20. When the assembly 12 is affixed in the container 90, the electrical cable(s) 80 can be operably connected to electrical bulkhead connection 82 positioned within a first sidewall (92a) of the container 90, and the first and second coolant lines 70a,b can extend away from the motor 40 and hydraulic pump 20 and can be operably connected to coolant bulkhead fittings 72 positioned within a second sidewall 92b of the container 90 that is opposite from the first sidewall. In such embodiments, the fluid inlet 60 and the fluid outlet 62 of the hydraulic pump 20 can be operably connected to hydraulic bulkhead fittings 62 also positioned within the second sidewall 92b of the container 90. Any type of electrical bulkhead connections can be used. For example, the electrical bulkhead connection 82 can comprise a polymer (e.g., optionally, rubber or silicone) grommet that can permit the electrical cable(s) 80 to pass therethrough. In some embodiments, electrical bulkhead connection 62 used in the disclosed system are the compression type that are liquid tight and allow the electrical cables 80 to pass through intact. Any type of coolant bulkhead fittings and hydraulic bulkhead fittings can be used. The container 90 can similarly define openings that provide communication of compressed air from the compressor to pneumatic brakes or other devices that use compressed air. Said openings for communicating compressed air can be provided anywhere on the container (e.g., top, sides, front, or back), depending on the compressor used and the location of the devices receiving the compressed air. The container 90 can be made of any suitable materials, such as fiberglass, plastic or metal, or any combination thereof. In some embodiments, the container 90 comprises metal. In some embodiments, the container 90 comprises fiberglass. In some embodiments, the container 90 comprises plastic. A schematic view of a system according to the disclosure received within a container is shown in FIG. 3 and FIG. 4.

In some embodiments, the disclosed system further comprises one or a plurality of vibration isolators 100 that are illustrated in FIGS. 1-2 and 5-6. The vibration isolators minimize vibration and noise from machinery to reduce maintenance costs, prolong equipment life, and protect floors. Any type of vibration isolators can be used, such as those provided in www.mcmaster.com/vibration-isolators/fail-safe-bolt-down-vibration-damping-mounts-with-threaded-hole/.

As shown in FIG. 1, the motor 40 of the disclosed system is cylindrically shaped in some embodiments. In some embodiments, an internal component of the motor 40 rotates internally about a longitudinal axis, and the first and/or second coolant lines 70 are positioned parallel to the longitudinal axis of the motor 40 along a line adjacent to a circumference of the motor 40. In some embodiments, the motor 40 is cylindrically shaped with two oppositely facing sides and rotates internally about a longitudinal axis, and the first and second coolant lines 70 are proximate to one of the oppositely facing sides of the motor 40, and the pump 20 is positioned adjacent to or substantially adjacent to the other oppositely facing sides. As shown in FIG. 1, in some embodiments, the pump 20 is positioned physically adjacent to the motor 40, but the hydraulic pump and motor are free of operable contact.

In some embodiments where the assembly 12 is received within, or affixed in, a container 90, the container can be of any dimension. In some embodiments, the container is from about 8 inches in height to about 36 inches in height. In some embodiments, the container is from about 8 inches in width to about 36 inches in width. In some embodiments, the container is from about 8 inches in length to about 36 inches in length. In some embodiments, the container is from about 12 inches in length, about 12 inches in width, and about 24 inches in height.

In some embodiments, the system 10 operates at no more than about 220 degrees Fahrenheit. In some embodiments, the system operates at no more than about 210 degrees Fahrenheit. In some embodiments, the system operates at no more than about 200 degrees Fahrenheit. In some embodiments, the system operates at no more than about 190 degrees Fahrenheit. In some embodiments, the system operates at no more than about 180 degrees Fahrenheit. In some embodiments, the system operates at no more than about 170 degrees Fahrenheit. In some embodiments, the system operates at no more than about 160 degrees Fahrenheit. In some embodiments, the system operates at no more than about 150 degrees Fahrenheit. In some embodiments, the system operates at no more than about 140 degrees Fahrenheit. In some embodiments, the system operates at no more than about 130 degrees Fahrenheit. In some embodiments, the system operates at no more than about 120 degrees Fahrenheit.

In some embodiments, the system 10 operates from about 120 to about 220 degrees Fahrenheit. In some embodiments, the system operates from about 130 to about 210 degrees Fahrenheit. In some embodiments, the system operates from about 140 to about 200 degrees Fahrenheit. In some embodiments, the system operates from about 150 to about 190 degrees Fahrenheit. In some embodiments, the system operates from about 160 to about 180 degrees Fahrenheit. In some embodiments, the system operates from about 140 to about 220 degrees Fahrenheit.

In some embodiments, the system 10 of the disclosure further comprises an insulating material wrapping around the motor 40, the pump 20, and the compressor 30. In some embodiments, the insulating material comprises a sound absorption coefficient (also called noise-reduction coefficient or NRC) of from about 0.3 to about 1.0. The sound absorption coefficient can be the ratio of the sound energy absorbed by a material to the overall sound energy incident upon the material. In some embodiments, the insulating material comprises a sound absorption coefficient of from about 0.4 to about 1.0. In some embodiments, the insulating material comprises a sound absorption coefficient of from about 0.5 to about 1.0. In some embodiments, the insulating material comprises a sound absorption coefficient of from about 0.6 to about 1.0. In some embodiments, the insulating material comprises a sound absorption coefficient of from about 0.7 to about 1.0. In some embodiments, the insulating material comprises a sound absorption coefficient of from about 0.75 to about 1.0. In some embodiments, the insulating material comprises a sound absorption coefficient of from about 0.8 to about 1.0. In some embodiments, the insulating material comprises a sound absorption coefficient of from about 0.85 to about 1.0. In some embodiments, the insulating material comprises a sound absorption coefficient of from about 0.9 to about 1.0.

In some embodiments, the insulating material comprises a sound absorption coefficient of about 0.3. In some embodiments, the insulating material comprises a sound absorption coefficient of about 0.4. In some embodiments, the insulating material comprises a sound absorption coefficient of about 0.5. In some embodiments, the insulating material comprises a sound absorption coefficient of about 0.6. In some embodiments, the insulating material comprises a sound absorption coefficient of about 0.7. In some embodiments, the insulating material comprises a sound absorption coefficient of about 0.75. In some embodiments, the insulating material comprises a sound absorption coefficient of about 0.8. In some embodiments, the insulating material comprises a sound absorption coefficient of about 0.85. In some embodiments, the insulating material comprises a sound absorption coefficient of about 0.9. In some embodiments, the insulating material comprises a sound absorption coefficient of about 0.95. In some embodiments, the insulating material comprises a sound absorption coefficient of about 1.0.

In some embodiments, the insulating material comprises a sound absorption coefficient greater than about 0.5. In some embodiments, the insulating material comprises a sound absorption coefficient greater than about 0.6. In some embodiments, the insulating material comprises a sound absorption coefficient greater than about 0.7. In some embodiments, the insulating material comprises a sound absorption coefficient greater than about 0.75. In some embodiments, the insulating material comprises a sound absorption coefficient greater than about 0.8. In some embodiments, the insulating material comprises a sound absorption coefficient greater than about 0.85. In some embodiments, the insulating material comprises a sound absorption coefficient greater than about 0.9.

In some embodiments, the insulating material comprises a fiber and a binding agent. In some embodiments, the fiber comprises one or a combination of fiberglass, mineral wool, or ceramic fiber. In some embodiments, the binding agent comprises one or a combination of a resin or polymer. In some embodiments, the polymer comprises one or a combination of a terpolymer or quarterpolymer. In some embodiments, the insulating material is fabric or textile in the form of a blanket, bat insulation, or board. In some embodiments, the insulating material covers at least one surface of a container enclosing the pump, a container enclosing the assembly 12, or a container enclosing the motor. In some embodiments, the insulating material covers a surface of the container that is the internal surface and in some embodiments, the insulating material covers a surface of the container that is the external surface.

Examples of the insulating material suitable for wrapping around the motor 40, the pump 20, and the compressor 30 of the disclosure include, but are not limited to, polypropylene foam sheets such as water-resistant rigid sound-absorbing sheets by McMaster-Carr (www.mcmaster.com/9107T12/), acrylic plastic and butyl rubber sheets such as vibration damping sheet by McMaster-Carr (www.mcmaster.com/9709T29/), polyurethane foam sheets such as vibration damping sheet by McMaster-Carr (www.mcmaster.com/9709T72/), butyl and aluminum constrained-layer vibrational dampers by Dynamat Inc. (www.dynamat.com/wp-content/uploads/2021/02/2010-Dynamat-Xtreme-Sell-Sheet_Web.pdf), QUIET BARRIER™ HD (w/PSA) soundproofing material sheets by Soundproof Cow Corporate (https://www.soundproofcow.com/product/quict-barrier % c2% ad-hd-soundproofing-material-shect-psa/), QUIET BATTIM 30 Soundproofing Insulation by Soundproof Cow Corporate (https://www.soundproofcow.com/product/quict-batt-30-soundproofing-insulation/), mineral wool insulation materials such as THERMAFIBER® SAFB™ (Sound Attenuation Fire Blanket) by Owens Corning (www.owenscorning.com/en-us/insulation/products/thermafiber-safb-sound-attenuation-fire-blanket), SELECTSOUND® Black Acoustic Blanket by Owens Corning (www.owenscorning.com/en-us/insulation/products/selectsound-black-acoustic-blanket), and a combination of any of such materials.

In some embodiments, the system of the disclosure can further comprise a controller operably linked to the motor and the hydraulic pump and a coolant reservoir. In some embodiments, the coolant reservoir is at a position distal from the container enclosing the assembly 12. In other embodiments, the system of the disclosure can further comprise an inverter in operable connection to the motor through one or a plurality of cables or wires.

In some embodiments, the system 10 is affixed to a motor vehicle (or other mounting surface) by a connector. In some embodiments the container is affixed to the motor vehicle by a connector. In some embodiments, the connector comprises one or both of a vibration isolator 100 or at least one connecting element (e.g., a fastener). In some embodiments, the connecting element passes through the vibration isolator. In some embodiments, the vibration isolator is positioned between the container and one or both of the electric motor or hydraulic pump. In some embodiments, the connecting element passes through at least one surface of the container to affix the electric motor and/or hydraulic pump to the motor vehicle. In some embodiments, the connecting element comprises one or a combination of a nail, a screw, a fastener, a rivet, a bolt, a nut, or a tie. In exemplary aspects, the container 90 can define openings 94 that receive therethrough the connector (e.g., the fasteners and vibration isolators 100, as illustrated). Accordingly, in some aspects, the assembly 12 is not directly coupled to the container 90, thereby isolating the container 90 from the vibrations of the assembly, reducing sound transfer from the assembly through the container and further removing mechanical stress on the container. For example, instead of a direct coupling, the assembly 12 can be coupled to a mounting surface, and the container 90 can likewise be coupled to the mounting surface, thereby indirectly coupling the assembly 12 to the container. This can inhibit the vibrations from the assembly 12 from transferring to and vibrating the container 90. The mounting surface can be, for example, a frame of a vehicle or other equipment or machinery. The mounting surface can be a beam, a strut, a sheet, or any suitable surface for mounting and supporting the assembly 12.

The system of the disclosure is suitable for incorporating into a motor vehicle, particularly for generating hydraulic fluid flow for steering and braking, or to perform auxiliary functions such as dump bodies for garbage trucks or landscape trucks. In some embodiments, therefore, the disclosure provides a motor vehicle comprising any of the systems disclosed herein. One of such embodiments is shown in FIG. 7, which a schematic view showing an embodiment of an electric pump according to the present disclosure attached to a frame of a vehicle. The assembly 12 is enclosed in the container 90. The assembly 12 is affixed in the container 90 by the electrical bulkhead connections 82, the coolant bulkhead fittings 72, and the hydraulic bulkhead fittings 62.

In some embodiments, a hydraulic pump assembly is provided, the hydraulic pump assembly comprising an electric motor, a hydraulic pump, and electric cable. In some embodiments, the hydraulic pump comprises a first housing, a first interior rotating segment (comprising drive shaft 22), a fluid inlet, and a fluid outlet. In some embodiments, the fluid outlet and fluid inlet are together capable of being in closed fluid communication with a fluid circuit of motor vehicle; the fluid circuit of the motor vehicle comprising a brake hydraulic system, a steering hydraulic system, or a transmission system. In some embodiments, the first interior rotating segment turns within the first housing and is capable of providing fluid flow to the fluid through the fluid inlet and the fluid outlet.

In some embodiments, the electric motor comprises a second housing, a second interior rotating segment (comprising output shaft 42), a first coolant line, and a second coolant line. In some embodiments, the electric motor is cylindrical in shape, having a long axis, and the second interior rotating segment rotating along the long axis within the second housing. In some embodiments, the second interior rotating segment of the electric motor is affixed to the first interior rotating segment of the pump. In some embodiments, the first coolant line comprises a first segment and a second segment; the first segment being positioned along the outside periphery of the electric motor; and the second segment being positioned along the interior of the motor; the first segment and second segment providing a fluidic pathway for coolant around the motor. In some embodiments, the second coolant line comprises a third segment and a fourth segment; the third segment being positioned along the interior of the motor; the first segment being in fluidic coolant communication with the third segment; the fourth segment being positioned along the outside periphery of the motor; the second segment being in fluidic coolant communication with the second segment. In some embodiments, the third segment comprises a coolant outlet. In some embodiments, the second segment comprises a coolant inlet.

In some embodiments, the second housing or the second interior rotating segment comprises wound electrical conductors, which are in electrical communication with the electric cable and are capable of inducing an electromagnetic field; the electromagnetic field being capable of turning the second interior rotating segment when an electrical potential is provided by the electric cable. In some embodiments, the hydraulic pump assembly further comprises a container; the container comprising a surface, an electrical bulkhead connector, a coolant bulkhead fitting, or a hydraulic bulkhead fitting. In some embodiments, one or a combination of the electrical bulkhead connector, the coolant bulkhead fitting, or the hydraulic bulkhead fitting are affixed to the surface. In some embodiments, the electrical bulkhead connector are connected to the electric cable. In some embodiments, one or a combination of the coolant inlet or coolant outlet is affixed to one or more coolant bulkhead fittings. In some embodiments, one or a combination of the fluid inlet and fluid outlet are affixed to one or more hydraulic bulkhead fittings.

It is contemplated that the disclosed system has various advantages, including requiring only one motor to drive both the pump and the compressor. Further, the disclosed system is compact, requiring minimal space within a vehicle. Still further, the disclosed system can provide noise reduction leading to noise levels well below noise generated by conventional pumps and compressors.

### Methods

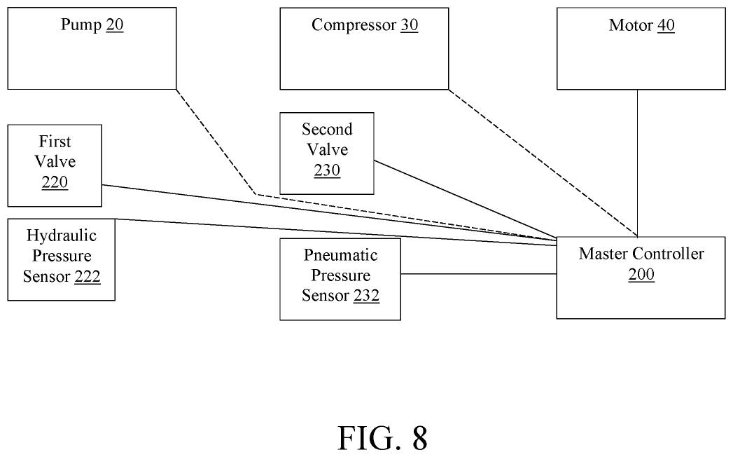

The disclosure further relates to methods of operating any of the systems disclosed herein. Referring to FIG. 8, in some embodiments, system comprises a master controller 200 controlling rate of hydraulic fluid through the disclosed circuit. In some embodiments, the master controller comprises a fluid controller and a coolant controller. In some embodiments, the fluid controller and the coolant controller are the same. In some embodiments, such methods further comprise turning on or off the motor 40. In some embodiments, such methods further comprise turning on or off the hydraulic pump 20. In some embodiments, such methods further comprise turning on or off both the motor 40 and the hydraulic pump 20. In some embodiments, the master controller turns on or off the motor. In some embodiments, the master controller turns on or off the hydraulic pump. In some embodiments, in some embodiments, the master controller turns on or off both the motor 40 and the hydraulic pump 20.

In some aspects, the master controller 200 can be configured to operate valves in order to independently enable or disable each of the pump and the compressor. In this way, one of hydraulic pressure or pneumatic pressure can be adjusted without slowing or stopping the motor, thereby undesirably limiting the other of the hydraulic pressure or the pneumatic pressure. Such valves can optionally be positioned external to the container 90. For example, a first valve 220 can be opened to reduce hydraulic power. For example, the first valve 220 can provide a bypass that connects the inlet and outlet of the hydraulic pump. In this way, excess hydraulic pressure can be vented from the hydraulic system. In further aspects, a second valve 230 can be in communication with the pneumatic system and can be configured to open to relieve pneumatic pressure within the pneumatic system. In some aspects, a first pressure sensor 222 can be in communication with the outlet of the hydraulic pump. The first pressure sensor 222 can be operably coupled to the master controller. In further aspects, a second pressure sensor 232 can be in communication with the outlet of the compressor. The second pressure sensor 232 can be operably coupled to the master controller. Accordingly, the master controller 200 can operate the first and second valves based on pressure readings from the first and second pressure sensors.

In some embodiments, the system comprises a coolant controller operably linked to the motor and the hydraulic pump and a coolant reservoir, such methods comprise engaging the coolant controller to circulate coolant within one or both of the first and second coolant lines. In some embodiments, the coolant controller regulates an increase or a decrease in the amount of coolant in the coolant reservoir and/or to increase, decrease, and/or optimize the amount of coolant in the one or both of the first and second coolant lines. In some embodiments, the coolant controller is integral to the master controller. In some embodiments, the coolant controller is discrete from the master controller.

In some embodiments, the system further comprises a fluid controller. In some embodiments, the fluid controller engages the fluid communication through one or more of the fluid inlet and fluid outlet to increase or decrease the amount of fluid in the fluid reservoir and/or to increase, decrease, and/or optimize the fluid volume in the fluid circuit. In some embodiments, the fluid comprises one or a combination of oil, power steering fluid, power brake fluid, or transmission fluid. In some embodiments, the fluid controller and/or the master controller controls the rate of fluid flow through the pump over time. In some embodiments, the speed of the pump is accelerated or decelerated by the fluid and/or master controller. In some embodiments, the speed of the pump is continuously controlled over time by the fluid and/or master controller. In some embodiments, the rate of fluid flow through the pump is maintained as constant or substantially constant. In some embodiments, the fluid controller is integral to the master controller. In some embodiments, the fluid controller is discrete from the master controller. In some embodiments, the coolant controller is integral to the fluid controller. In some embodiments, the coolant controller is discrete from the fluid controller.

An operator of the vehicle comprising the disclosed system may select, de-select, or program the rate of fluid flow and/or the rate of coolant flow through one or more monitors or displays in electric communication with a computer memory and the controller. In some embodiments, the operator of the vehicle comprising the disclosed system may select, de-select, or program the rate of fluid flow and/or the rate of coolant flow through one or more monitors or displays in electric communication with a computer memory master, fluid, and/or coolant controller via simple wire connection. In some embodiments, the coolant controller increases and/or decreases the rate of flow of coolant based on based on the temperature of the coolant, wherein an increase in the temperature increases the rate of flow of coolant and a decrease in temperature decreases the rate of flow of coolant. In some embodiments, an operator may select, de-select, or program increases or decreases in the rate of flow based on an increase or decrease in the temperature of the coolant (e.g. by increasing the coefficient (i.e. slope of a line) of the relationship between an increase in rate of flow and an increase in temperature or by increasing the set-point (i.e. y- or x-intercept of a line) by which all other increases or decreases in the rate of flow per increase or decrease in degree of temperature are factored).

In some embodiments, the system comprises electrical cables. In some embodiments, the electrical cables are in electrical communication with the electric motor and form a circuit with the battery or plurality of batteries in the vehicle. In some embodiments, the electrical cables are in electrical communication with one or a combination of the master controller, fluid controller, or coolant controller. In some embodiments, the master controller, fluid controller, and coolant controller are in electrical communication with the electric motor. In some embodiments, the electrical cables are in electrical communication with the motor vehicle. In some embodiments, the electrical cables are in electrical communication with the one or a combination of the inverter, battery, or electrical system of the motor vehicle.

The disclosure also provides a method of manufacturing any of the systems disclosed herein comprising affixing the first and second coolant lines to the motor. In some embodiments, the method further comprises affixing the hydraulic pump proximate to or substantially proximate to the motor. In some embodiments, the hydraulic pump is positioned physically adjacent to the motor but are free of operable contact.

The disclosure additionally provides a method of manufacturing a motor vehicle comprising installing any of the systems disclosed herein into a motor vehicle. In some embodiments, the assembly 12 is enclosed in a container before installing into the motor vehicle. In some embodiments, the assembly 12 is wrapped in an insulating material and then enclosed in a container. In some embodiments therefore, the disclosure provides a motor vehicle comprising a soundproofed system disclosed herein as part of the heating management system.

It should be noted that, the above embodiments are only intended for describing the present disclosure, and should not be interpreted as limitation to the technical solutions of the present disclosure. Although the present disclosure is described in detail in conjunction with the above embodiments, it should be understood by the skilled in the art that, modifications or equivalent substitutions may still be made to the present disclosure by those skilled in the art; and any technical solutions and improvements thereof without departing from the spirit and scope of the present disclosure also fall into the scope of the present disclosure defined by the claims.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A system comprising:
(a) a motor comprising an output shaft;
(b) an air compressor comprising a drive shaft coupled to the output shaft of the motor so that rotation of the motor drives the air compressor; and
(c) a hydraulic pump comprising a drive shaft that is coupled to the output shaft of the motor so that rotation of the motor drives the hydraulic pump.

Aspect 2: The system of aspect 1, wherein the drive shaft of the air compressor is coupled to the drive shaft of the hydraulic pump so that that the air compressor and the hydraulic pump are configured rotate at the same speed.

Aspect 3: The system of aspect 1 or aspect 2, wherein the output shaft of the motor, the drive shaft of the air compressor, and the drive shaft of the hydraulic pump are configured to rotate about a single axis.

Aspect 4: The system of any one of the preceding aspects, wherein the motor comprises a housing, wherein one of the air compressor or the hydraulic pump is coupled to the housing of the motor.

Aspect 5: The system of aspect 4, wherein the hydraulic pump has a housing, wherein the air compressor has a housing, wherein other of the air compressor or the hydraulic pump is coupled to the housing of the one of the air compressor or the hydraulic pump.

Aspect 6: The system of any one of the preceding aspects, wherein the motor comprises a housing, wherein the air compressor comprises a housing, wherein the housing of the air compressor is coupled to the housing of the motor.

Aspect 7: The system of aspect 6, wherein the hydraulic pump has a housing, wherein the housing of the hydraulic pump is coupled to the housing of the air compressor.

Aspect 8: The system of aspect 7, wherein the housing of the hydraulic pump is directly coupled to the housing of the air compressor, and wherein the housing of the air compressor is directly coupled to the housing of the motor.

Aspect 9: The system of any one of the preceding aspects, wherein the hydraulic pump comprises an outlet, wherein the air compressor comprises an outlet, the system further comprising:
a first pressure sensor in communication with the outlet of the hydraulic pump;
a second pressure sensor in communication with the outlet of the air compressor;
a first valve that is configured to reduce a pressure at the outlet of the hydraulic pump or the air compressor;
a controller in operable communication with the motor, the first and second pressure sensors and the first valve, wherein the controller is configured to operate the first valve to selectively reduce the pressure at the outlet of the hydraulic pump or the air compressor.

Aspect 10: The system of aspect 9, wherein the first valve is configured to reduce a pressure at the outlet of the hydraulic pump, the system further comprising a second valve that is configured to reduce a pressure at the outlet of the air compressor,
wherein the controller is in operable communication with the second valve, wherein the controller is configured to operate each of the first and second valves to control the pressure at each of the outlets of the hydraulic pump and the air compressor.

Aspect 11: The system of aspect 9 or aspect 10, wherein the controller is configured to selectively turn the motor on or off.

Aspect 12: The system of any one of the preceding aspects, wherein the air compressor is a piston compressor, a scroll compressor, or a screw compressor.

Aspect 13: The system of any one of the preceding aspects further comprising a container comprising at least one sidewall, wherein the container defines an interior, wherein the motor, the hydraulic pump, and the air compressor are all received within the interior of the container.

Aspect 14: The system of aspect 13, wherein the container defines a plurality of openings that are configured to receive therethrough connectors for connecting the container to a mounting surface.

Aspect 15: The system of aspect 14, further comprising said connectors, wherein the connectors comprise vibration isolators and fasteners, wherein the connectors extend through respective openings of the plurality of openings.

Aspect 16: The system of aspect 1, wherein the motor has an outside periphery and an interior, wherein the system further comprises:
(d) a first coolant line defining a fluid pathway for coolant around the motor, wherein a first segment of the first coolant line is positioned along the outside periphery of the motor and a second segment of the first coolant line is positioned along the interior of the motor; and
(e) a second coolant line operably connected to the first coolant line and defining a fluid pathway for coolant around the motor, wherein a first segment of the second coolant line is positioned along the interior of the motor and a second segment of the second coolant line is positioned along the outside periphery of the motor.

Aspect 17: The system of aspect 16 further comprising a container comprising at least one sidewall, wherein the container defines an interior, wherein the motor, the hydraulic pump, and the air compressor are all received within the interior of the container, wherein the container comprises a first coolant bulkhead fitting, and a second coolant bulkhead fitting, and wherein the first and second coolant lines extend away from the motor and pump and are operably connected to coolant bulkhead fittings positioned within the at least one sidewall.

Aspect 18: The system of any one of aspects 13 through 17, wherein the container is a cylindrical or rectangular based prism, cuboid, or parallelepiped and comprises one or a plurality of surfaces that define an interior volume.

Aspect 19: The system of aspect 18, wherein the container is a rectangular based prism, cuboid or parallelepiped and comprises six surfaces, which define the interior volume, wherein the two lateral surfaces are parallel sidewalls and at least one surface is movable, such that the movable surface allows access to and from the interior volume.

Aspect 20: The system of aspect 19, wherein the movable surface is movable radially downward or upward about at least one edge on the container.

Aspect 21: The system of aspect any one of aspects 13 through 20, wherein the container comprises fiberglass, plastic, or metal.

Aspect 22: The system of aspect any one of aspects 16 through 21, wherein the first or second coolant line comprises at least one segment that runs along a longitudinal axis of the motor.

Aspect 23: The system of any one of aspects 16 through 22, wherein the first or second coolant line comprises at least one segment that runs along a longitudinal axis of the hydraulic pump.

Aspect 24: The system of any one of aspects 16 through 23, wherein the motor is cylindrically shaped, and wherein the first and/or second coolant lines are positioned parallel to a longitudinal axis of the motor along a line adjacent to a circumference of the motor.

Aspect 25: The system of any one of aspects 16 through 24, wherein the motor is cylindrically shaped with two oppositely facing sides, wherein the first and second coolant lines are proximate to one of the oppositely facing sides of the motor, and wherein the hydraulic pump is positioned adjacent to or substantially adjacent to the other oppositely facing sides.

Aspect 26: The system of any one of aspects 16 through 24, wherein the motor is cylindrically shaped with two oppositely facing sides, wherein the first and second coolant lines are proximate to one of the oppositely facing sides of the motor, and wherein the air compressor is positioned adjacent to or substantially adjacent to the other oppositely facing sides.

Aspect 27: The system of the preceding aspects further comprising an insulating material wrapped around the motor, the hydraulic pump, and the air compressor, wherein the insulating material comprises a sound absorption coefficient from about 0.3 to about 1.0.

Aspect 28: The system of any one of the preceding aspects, further comprising:
a coolant reservoir; and
a controller operably linked to the motor and the hydraulic pump and a coolant reservoir.

Aspect 29: The system of any one of the preceding aspects further comprising an inverter in operable connection to the motor through one or a plurality of cables or wires.

Aspect 30: A motor vehicle comprising a system as in any one of the preceding aspects.

Aspect 31: The motor vehicle of aspect 30, wherein the motor vehicle is a utility vehicle or a truck.

Aspect 32: A method comprising:
(f) coupling an output shaft of a motor to a drive shaft of an air compressor so that rotation of the motor drives the air compressor; and
(g) coupling the output shaft of the motor to a drive shaft of a hydraulic pump so that rotation of the motor drives the hydraulic pump.

Aspect 33: The method of aspect 32, wherein coupling the output shaft of the motor to the drive shaft of the hydraulic pump comprises indirectly coupling the output shaft of the motor to the drive shaft of the hydraulic pump by coupling the drive shaft of the hydraulic pump to the drive shaft of the air compressor.

Aspect 34: The method of aspect 32, wherein coupling the output shaft of the motor to the drive shaft of the air compressor comprises indirectly coupling the output shaft of the motor to the drive shaft of the air compressor by coupling the drive shaft of the air compressor to the drive shaft of the hydraulic pump.

Aspect 35: The method of any one of aspects 32 through 34 further comprising:
operably coupling the air compressor to a pneumatic system; and
operably coupling the hydraulic pump to a hydraulic system.

Aspect 36: The method of aspect 35, wherein the pneumatic and hydraulic systems are the pneumatic and hydraulic systems of a vehicle.

All referenced journal articles, patents, and other publications are incorporated by reference herein in their entireties.

What is claimed is:

1. A system comprising:
(a) a motor comprising an output shaft;
(b) an air compressor comprising a drive shaft coupled to the output shaft of the motor so that rotation of the motor drives the air compressor; and
(c) a hydraulic pump comprising a drive shaft that is coupled to the output shaft of the motor so that rotation of the motor drives the hydraulic pump.

2. The system of claim 1, wherein the drive shaft of the air compressor is coupled to the drive shaft of the hydraulic pump so that that the air compressor and the hydraulic pump are configured rotate at the same speed.

3. The system of claim 1, wherein the output shaft of the motor, the drive shaft of the air compressor, and the drive shaft of the hydraulic pump are configured to rotate about a single axis.

4. The system of claim 1, wherein the motor comprises a housing, wherein one of the air compressor or the hydraulic pump is coupled to the housing of the motor.

5. The system of claim 4, wherein the hydraulic pump has a housing, wherein the air compressor has a housing, wherein the other of the air compressor or the hydraulic pump is coupled to the housing of the one of the air compressor or the hydraulic pump.

6. The system of claim 1, wherein the motor comprises a housing, wherein the air compressor comprises a housing, wherein the housing of the air compressor is coupled to the housing of the motor.

7. The system of claim 6, wherein the hydraulic pump has a housing, wherein the housing of the hydraulic pump is coupled to the housing of the air compressor.

8. The system of claim 7, wherein the housing of the hydraulic pump is directly coupled to the housing of the air compressor, and wherein the housing of the air compressor is directly coupled to the housing of the motor.

9. The system of claim 1, wherein the hydraulic pump comprises an outlet, wherein the air compressor comprises an outlet, the system further comprising:
a first pressure sensor in communication with the outlet of the hydraulic pump;
a second pressure sensor in communication with the outlet of the air compressor;
a first valve that is configured to reduce a pressure at the outlet of the hydraulic pump or the air compressor; and
a controller in operable communication with the motor, the first and second pressure sensors and the first valve, wherein the controller is configured to operate the first valve to selectively reduce the pressure at the outlet of the hydraulic pump or the air compressor.

10. The system of claim 9, wherein the first valve is configured to reduce a pressure at the outlet of the hydraulic pump, the system further comprising a second valve that is configured to reduce a pressure at the outlet of the air compressor,
wherein the controller is in operable communication with the second valve, wherein the controller is configured to operate each of the first and second valves to control the pressure at each of the outlets of the hydraulic pump and the air compressor.

11. The system of claim 9, wherein the controller is configured to selectively turn the motor on or off.

12. The system of claim 1, wherein the air compressor is a piston compressor, a scroll compressor, or a screw compressor.

13. The system of claim 1 further comprising a container comprising at least one sidewall, wherein the container defines an interior, wherein the motor, the hydraulic pump, and the air compressor are all received within the interior of the container.

14. The system of claim 13, wherein the container defines a plurality of openings that are configured to receive therethrough connectors for connecting the container to a mounting surface.

15. The system of claim 14, further comprising said connectors, wherein the connectors comprise vibration isolators and fasteners, wherein the connectors extend through respective openings of the plurality of openings.

16. The system of claim 1, wherein the motor has an outside periphery and an interior, wherein the system further comprises:
(a) a first coolant line defining a fluid pathway for coolant around the motor, wherein a first segment of the first coolant line is positioned along the outside periphery of the motor and a second segment of the first coolant line is positioned along the interior of the motor; and
(b) a second coolant line operably connected to the first coolant line and defining a fluid pathway for coolant around the motor, wherein a first segment of the second coolant line is positioned along the interior of the motor and a second segment of the second coolant line is positioned along the outside periphery of the motor.

17. The system of claim 13, wherein the container is a cylindrical or rectangular based prism, cuboid, or parallelepiped and comprises one or a plurality of surfaces that define the interior volume.

18. The system of claim 8, wherein the motor is cylindrically shaped with two oppositely facing sides, wherein the first and second coolant lines are proximate to one of the oppositely facing sides of the motor, and wherein the air compressor is positioned adjacent to the other oppositely facing sides.

19. The system of claim 1 further comprising an insulating material wrapped around the motor, the hydraulic pump, and the air compressor, wherein the insulating material comprises a sound absorption coefficient from about 0.3 to about 1.0.

20. A method comprising:
(a) coupling an output shaft of a motor to a drive shaft of an air compressor so that rotation of the motor drives the air compressor; and
(b) coupling the output shaft of the motor to a drive shaft of a hydraulic pump so that rotation of the motor drives the hydraulic pump.
